(19) United States
(12) Patent Application Publication
(10) Pub. No.: US 2021/0026700 A1
(43) Pub. Date: Jan. 28, 2021

(54) MANAGING A CONTAINERIZED APPLICATION IN A CLOUD SYSTEM BASED ON USAGE

(71) Applicant: Hewlett Packard Enterprise Development LP, Houston, TX (US)

(72) Inventors: Siva Subramaniam Manickam, Bangalore Karnataka (IN); Thavamaniraja Sakthivel, Bangalore Karnataka (IN); Vinnarasu Ganesan, Bangalore Karnataka (IN); Balaji Balaji Ramamoorthi, Bangalore Karnataka (IN)

(21) Appl. No.: 16/522,312

(22) Filed: Jul. 25, 2019

(51) Int. Cl. G06F 9/50; G06F 16/903; H04L 29/08

(52) U.S. Cl. CPC G06F 9/5055; H04L 67/34; G06F 16/90335; G06F 9/5061

(57) ABSTRACT

Examples described relate to managing a containerized application in a cloud system based on usage. In an example, a determination may be made whether a containerized application in a cloud system has not been used for a pre-defined period of time. In response to the determination, the containerized application may be deleted. The information related to the containerized application in a database may be stored in a database. In response to a future user request to access the containerized application, a new containerized application may be created in the cloud system based on the information related to the containerized application in the database. A new public service endpoint may be associated with the new containerized application in the cloud system. User access to the new containerized application in the cloud system may be allowed via the new public service endpoint.

### BACKGROUND

The Information technology (IT) infrastructure of organizations may vary in scale and scope based on the size and requirements of organizations. For example, the number of software applications deployed in an organization may vary from a few basic software applications (for example, email) to large and complex applications.

### BRIEF DESCRIPTION OF THE DRAWINGS

For a better understanding of the solution, examples will now be described, with reference to the accompanying drawings, in which:

FIG. 1 is a block diagram of an example computing environment for managing a containerized application in a cloud system based on usage;

FIG. 2 is a block diagram of an example cloud system for managing a containerized application in a cloud system based on usage;

FIG. 3 is a flowchart of an example method of managing a containerized application in a cloud system based on usage;

FIG. 4 is a flowchart of an example method of managing a containerized application in a cloud system based on usage; and

FIG. 5 is a block diagram of an example system including instructions in a machine-readable storage medium for managing a containerized application in a cloud system based on usage.

### DETAILED DESCRIPTION

The IT environment of an enterprise may comprise a handful of software applications to hundreds of applications. Managing the entire software lifecycle of these applications may pose technical challenges. One of these challenges may relate to portability of a software application from one computing environment to another. In one example scenario, this may include porting an application from a staging environment to a production environment. In another example, an application may need to be ported from a physical machine environment to a virtual machine environment. Organizations are thus increasingly looking at simple portable solutions that could help them package, ship, and run their software applications on a variety of computing platforms. Software containers may offer one such option.

Software containers may provide a mechanism to securely run an application in an isolated environment, which may be packed with all its dependencies and libraries. A software container thus may include an entire runtime environment: an application, its dependencies, libraries, and configuration files that may be bundled into one package. Such an application package may be referred to as a “containerized application” or “container application”. Since an application may be run in an environment that the application expects, software containers may simplify testing and deployment of an application.

A cloud application deployed in a public cloud may be associated with a public endpoint. A public endpoint may include a unique domain name which is provided by a public cloud vendor. A public endpoint may be charged to a user, for example, on a per-hour basis.

Containerized applications are gaining acceptance at rapid pace since they are easy to deploy and use. In a cloud system, users may provision containerized applications depending on their requirements. Each deployed containerized application may provide services which may not be used all the time and running idle. These under or sporadically used containerized applications may use resources in the cloud infrastructure, which may lead to reduced network bandwidth, throughput, and network congestion. This in turn may increase the overall cost of network management and decrease the Quality of Service (QoS) offered by a cloud system. It may be useful if underutilized containerized applications could be identified and their lifecycle efficiently managed based on usage.

To address these technical challenges, the present disclosure describes various examples for managing a containerized application in a cloud system based on usage. In an example, a determination may be made whether a containerized application in a cloud system has not been used for a pre-defined period of time. In response to a determination that the containerized application in the cloud system has not been used for the pre-defined period of time, the containerized application in the cloud system may be deleted. However, the information related to the containerized application in a database may be stored in a database. In response to a future user request to access the containerized application, a new containerized application may be created in the cloud system based on the information related to the containerized application in the database. A new public service endpoint may be associated with the new containerized application in the cloud system. User access to the new containerized application in the cloud system may be allowed via the new public service endpoint.

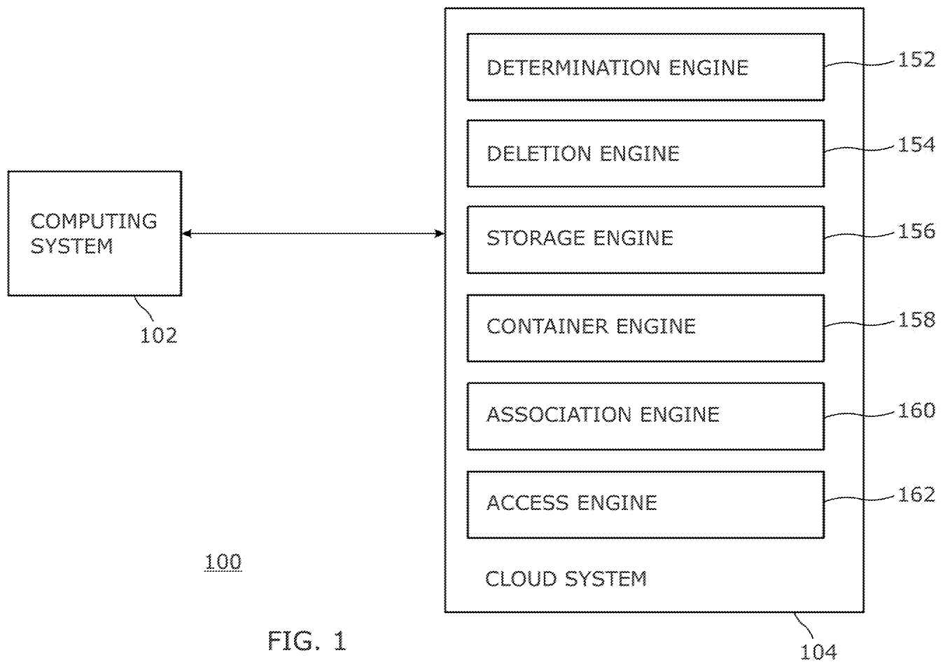

FIG. 1 is a block diagram of an example computing environment 100 for managing a containerized application in a cloud system based on usage. In an example, computing environment 100 may include a computing system 102 and a cloud system 104. Although one computing system and one cloud system is shown in FIG. 1, other examples of this disclosure may include more than one computing system and more than one cloud system.

In an example, computing system 102 may represent any type of computing device capable of reading machine-executable instructions. Examples of the computing device may include, without limitation, a server, a desktop computer, a notebook computer, a tablet computer, a thin client, a mobile device, and the like.

As used herein, the term “cloud system” (or “cloud”) may refer to an on-demand network access to a shared pool of information technology resources (e.g., networks, servers, storage, and/or applications) that can be quickly provisioned. Cloud system 104 may include a public cloud (or a public cloud system), a private cloud (or a private cloud system), or a hybrid cloud (or a hybrid cloud system). To explain briefly, a cloud may be termed a public cloud if cloud computing services are rendered over a public network such as the internet. On the other hand, a private cloud is a proprietary network that supplies services to a specific set of users. A hybrid cloud combines private and public cloud services.

In an example, cloud system 104 may include resources. As used herein, the “resources” in cloud system 104 may refer to software resources (machine-executable instructions) or hardware resources. These may include, for example, computing resources, network resources, and/or storage resources. Computing resources may be a hardware computing resource (e.g., includes at least one processor). The hardware computing resource may represent any type of system capable of reading machine-executable instructions. Examples of the hardware computing resource may include a server, a desktop computer, a notebook computer, a tablet computer, a thin client, a mobile device, a personal digital assistant (PDA), and the like. In an example, computing resources may represent software resources (machine-executable instructions). The software resources may include, for example, operating system software, firmware, and application software. Other examples of the software resources may include virtual machines, virtual servers, load balancers, firewalls, etc. In an example, computing resources may be a combination of hardware and software resources.

Network resources may include a network device, a network software, or any combination thereof. Some non-limiting examples of the network device may include a hub, a network switch, a network router, a virtual switch, and a virtual router. Some non-limiting examples of the network software may include Transmission Control Protocol (TCP), User Datagram Protocol (UDP), and OpenSwitch Linux Network Operating System.

Storage resources may include a storage device, a storage software, or any combination thereof. The storage device may be an internal storage device, an external storage device, or a network attached storage device. Other examples of the storage device may include a hard disk drive, a storage disc (for example, a CD-ROM, a DVD, etc.), a storage tape, a solid state drive, a USB drive, a Serial Advanced Technology Attachment (SATA) disk drive, a Fibre Channel (FC) disk drive, a Serial Attached SCSI (SAS) disk drive, a magnetic tape drive, an optical jukebox, and the like. In other examples, the storage device may be a Direct Attached Storage (DAS) device, a Network Attached Storage (NAS) device, a Redundant Array of Inexpensive Disks (RAID), a data archival storage system, or a block-based device over a storage area network (SAN).

The resources may be accessed by users (for example, via computing system 102) or by applications, for example, for providing or deploying a cloud service. In an example, cloud system 104 may provide or deploy various types of cloud services. These services may include, for example, Infrastructure as a Service (IaaS), Platform as a Service (PaaS), and Software as a Service (SaaS).

In an example, cloud system 104 may include a cloud platform. As used herein, a “cloud platform” may refer to a tool (software and/or hardware) which may be used to manage resources in cloud system 104. In an example, cloud platform may be used to manage, for example, computing resources, network resources, and/or storage resources in cloud system 104. In an example, one or more of computing resources, network resources, and/or storage resources may be used by the cloud platform to provide a cloud service (for example, IaaS) to a user. From a user's perspective, the cloud platform may be used, for example, to request a new cloud service and manage an existing cloud service via computing system 102. Users may also use the cloud platform to view a status of a pending cloud service request, pending approvals, and approved service subscriptions. A non-limiting example of the cloud platform may include OpenStack.

In an example, cloud system 104 may deploy one or a plurality of containerized applications. For example, cloud system 104 may deploy a Node.JS Web container application for an E-commerce service, a DB container application for database workload, and a NoSQL container application for unstructured data.

In an example, cloud system 104 may include a determination engine 152, a deletion engine 154, a storage engine 156, a container engine 158, an association engine 160, and an access engine 162. In an example, determination engine 152, deletion engine 154, storage engine 156, container engine 158, association engine 160, and access engine 162 may be a part of a cloud platform (e.g., machine-executable instructions). In an example, cloud platform may be used by a user to deploy a container on cloud system 104. The cloud platform may be hosted on one or a plurality of computing resources on cloud system 104.

Engines 152, 154, 156, 158, 160, and 162 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one of engines 152, 154, 156, 158, 160, and 162. In some examples, the at least one machine-readable storage medium may store instructions that, when executed by the at least one processing resource, at least partially implement some or all of engines 152, 154, 156, 158, 160, and 162. In such examples, the cloud system 104 may include the at least one machine-readable storage medium storing the instructions and the at least one processing resource to execute the instructions. In an example, cloud system 104 may be any combination of hardware and programming.

In an example, determination engine 152 may determine whether a containerized application in cloud system 104 has not been used for a pre-defined period of time. Examples of the containerized application may include Node.JS Web container application, DB container application, NoSQL container application, Web container application, and DevOps container application.

The pre-defined period of time may be defined by a user. In an example, the determination engine 152 may determine whether the containerized application in cloud system 104 has not been used for a pre-defined period of time based on network utilization by the containerized application within the pre-defined period of time. The determination based on network utilization may consider network Input/Output Operations per second (IOPS), which may be measured as number of packets received/sent per second. Peak usage over a period of time may be calculated and percentage of usage may be calculated using the total bandwidth of the NIC. For example, Peak Network IO %=(Peak IOPS)*100/(Total Bandwidth of the NIC)

In another example, the determination may be based on storage utilization by the containerized application within the pre-defined period of time. The determination may be based on storage utilization may consider storage IOPS, which may be measured as I/O (read and write) operations performed per second. Peak usage over a period of time may be calculated and percentage of usage may be calculated using the total disk bandwidth. For example, Peak Storage IO %=(Peak IOPS)*100/(Total Bandwidth of the disk). In a further example, the determination may be based on CPU utilization by the containerized application within the predefined period.

In an example, determination engine 152 may use a third-party tool to determine, for example, network utilization, storage utilization, and/or CPU utilization by the containerized application within the predefined period.

In response to a determination that the containerized application in the cloud system 104 has not been used for the pre-defined period of time, deletion engine 154 may delete the containerized application in cloud system 104. However, storage engine 156 may store information related to the deleted containerized application in a database, for example, on cloud system 104. In an example, the information related to the containerized application may comprise information related to a public service endpoint associated with the containerized application. In another example, the information related to the containerized application may comprise information related to a storage location of persistent data of the containerized application. As used herein, the term persistent data may include data that survives after the process with which it was created has ended. In an example, the data associated with the containerized application may be persisted outside of the container, which means it will be available when the containerized application is deleted. In an example, information related to the storage location of persistent data of the containerized application may include information related to a storage volume where the persistent data is stored. In an example, information related to the containerized application may comprise, for example, information related to container image path and version, exposed port mapping information, volumes attached to the containerized application, command to run on startup of containerized application, and/or environment variables passed to the containerized application.

There may be a scenario where a request to access the deleted containerized application may be made in future. For example, a user may try to access the deleted containerized application in future. In such case, in response to a request to access the deleted containerized application, container engine 158 may create a new containerized application in the cloud system 104 based on information related to the deleted containerized application in the database. Container engine 158 may associate persistent data of the containerized application with the new containerized application.

Association engine 160 may associate a new public service endpoint with the new containerized application in the cloud system 104. In an example, associating the new public service endpoint with the new containerized application in the cloud system 104 may comprise creating the new public service endpoint. Once the new public service endpoint is created, association engine 160 may associate the new public service endpoint with the new containerized application. In an example, the new public service endpoint may be created by a user. In an example, the new public service endpoint may be a domain name.

Once the new public service endpoint is associated with the new containerized application, access engine 162 may allow access to the new containerized application in the cloud system 104 via the new public service endpoint.

In an example, a user may access the containerized application in cloud system 104 through an Application Programming Interface (API) thin layer. When a user tries to access the containerized application through the API thin layer endpoint, the API thin layer may forward the request to the public service endpoint associated with the containerized application. If the containerized application is active and running, it may respond with an appropriate response which may then be redirected by the API thin layer to the user.

In another scenario, if a user tries to access the containerized application, which has been deleted, through the API thin layer, the API thin layer may forward the request to the public service endpoint associated with the containerized application. Since the containerized application is deleted, the cloud system 104 may respond with an error message, which is received by the API thin layer. In such case, the API thin layer may cache the request sent by the user. The API thin layer may verify and obtain the information related to the deleted containerized application from the database. The API thin layer may then make a request to create a new containerized application using the information related to the deleted containerized application from the database. Container engine 158 may create a new containerized application in the cloud system 104 based on the information related to the deleted containerized application in the database. Container engine 158 may associate persistent data of the deleted containerized application with the new containerized application. Association engine 160 may associate a new public service endpoint with the new containerized application in the cloud system 104. Container engine 158 may respond to the API thin layer once the container application is up and running along with the new public service endpoint. The API thin layer may resend the cached request to the new public service endpoint. The new containerized application associated with the new public service endpoint may provide an appropriate response to the API thin layer. The API thin layer may then share the response with the user.

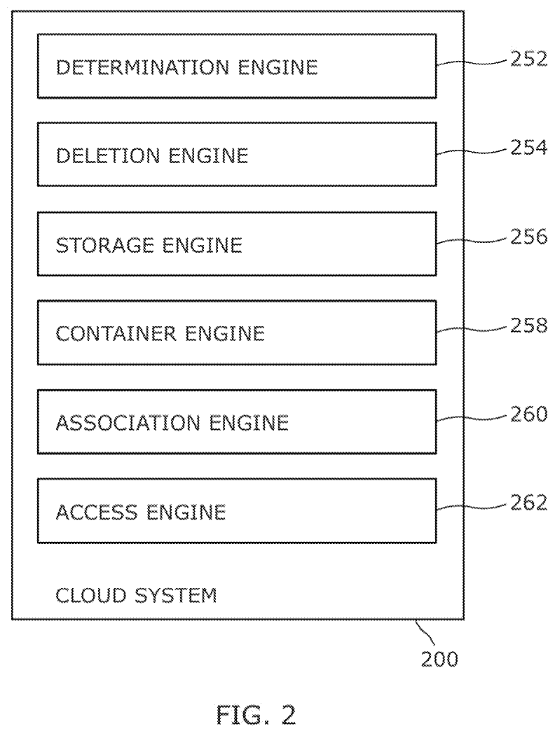

FIG. 2 is a block diagram of an example cloud system 200 for managing a containerized application based on usage. In an example, cloud system 200 may be analogous to the cloud system 104 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, cloud system 200 may include a determination engine 252, a deletion engine 254, a storage engine 256, a container engine 258, an association engine 260, and an access engine 262. In an example, determination engine 252, deletion engine 254, storage engine 256, container engine 258, association engine 260, and access engine 262 may perform functionalities similar to those described earlier in reference to determination engine 152, deletion engine 154, storage engine 156, container engine 158, association engine 160, and access engine 162 of FIG. 1, respectively.

In an example, determination engine 252 may determine whether a containerized application in a cloud system has not been used for a pre-defined period of time. In response to a determination that the containerized application in the cloud system has not been used for the pre-defined period of time, deletion engine 254 may delete the containerized application in the cloud system. Storage engine 256 may store information related to the containerized application in a database. In an example, the information related to the containerized application comprises information related to a public service endpoint associated with the containerized application, and information related to storage location of persistent data of the containerized application. In response to a future request to access the containerized application, container engine 258 may create a new containerized application in the cloud system based on the information related to the containerized application in the database. Association engine 260 may associate a new public service endpoint with the new containerized application in the cloud system. Access engine 262 may allow access to the new containerized application in the cloud system via the new public service endpoint.

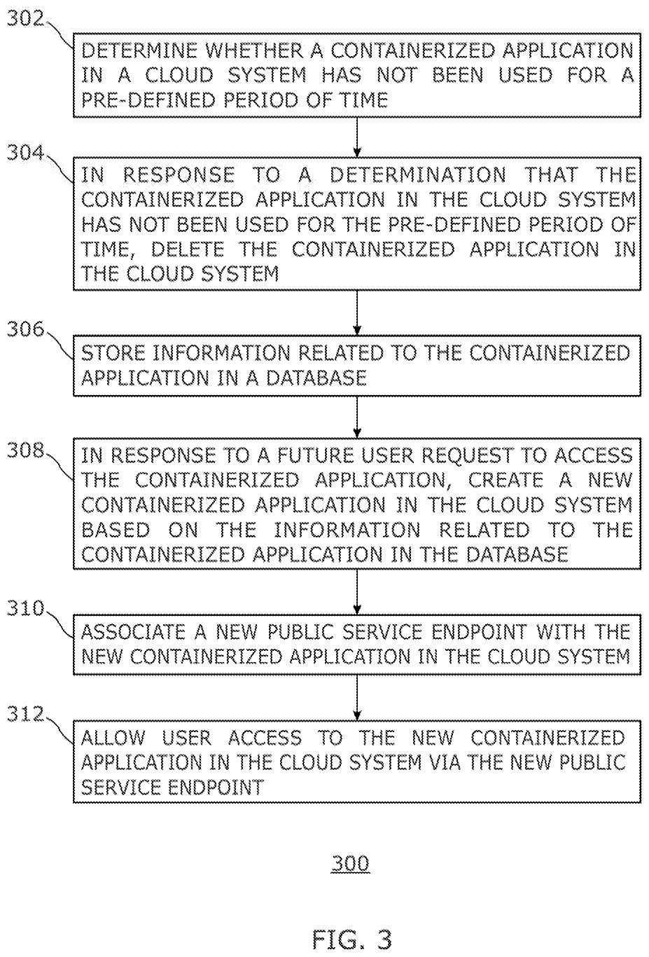

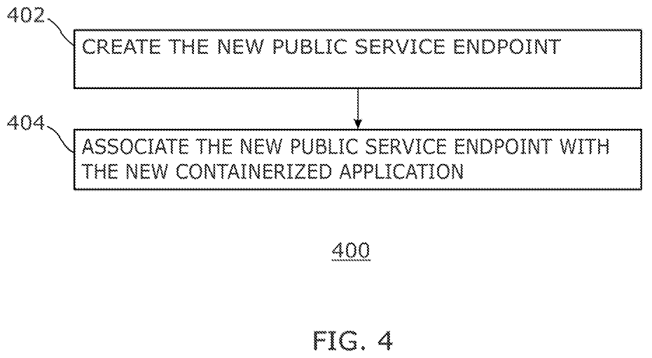

FIG. 3 is a flowchart of an example method 300 of managing a containerized application in a cloud system based on usage. The method 300, which is described below, may be executed on a cloud system such as cloud system 104 of FIG. 1 or cloud system 200 of FIG. 2. However, other computing platforms or computing devices may be used as well. At block 302, a determination may be made whether a containerized application in a cloud system has not been used for a pre-defined period of time. At block 304, in response to a determination that the containerized application in the cloud system has not been used for the pre-defined period of time, the containerized application in the cloud system may be deleted. At block 306, the information related to the containerized application in a database may be stored in a database. At block 308, in response to a future user request to access the containerized application, a new containerized application may be created in the cloud system based on the information related to the containerized application in the database. At block 310, a new public service endpoint may be associated with the new containerized application in the cloud system. This is illustrated in block 402 of FIG. 4, which illustrates example method 400 of associating the new public service endpoint with the new containerized application in the cloud system. At block 404, the new public service endpoint is associated with the new containerized application. Referring back to FIG. 3, at block 312, access to the new containerized application in the cloud system may be allowed via the new public service endpoint.

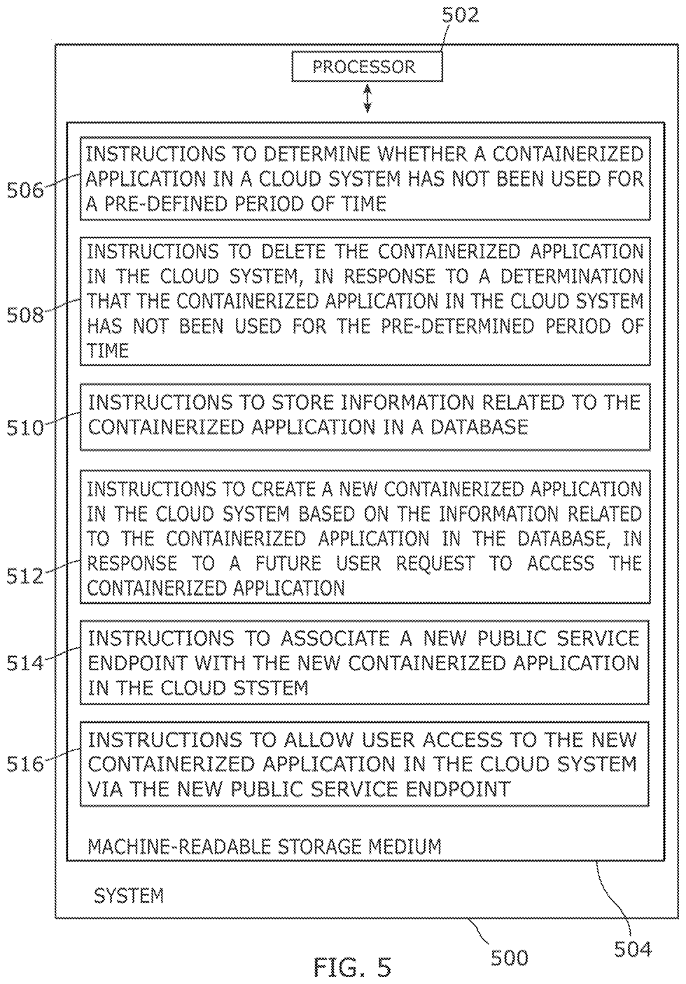

FIG. 5 is a block diagram of an example system 500 including instructions in a machine-readable storage medium for managing a containerized application in a cloud system based on usage. System 500 includes a processor 502 and a machine-readable storage medium 504 communicatively coupled through a system bus. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, 512, 514, and 516.

In an example, instructions 506 may be executed by processor 502 to Instructions 508 may be executed by processor 502 to determine whether a containerized application in a cloud system has not been used for a pre-defined period of time. Instructions 508 may be executed by processor 502 to delete the containerized application in the cloud system, in response to a determination that the containerized application in the cloud system has not been used for the pre-defined period of time. Instructions 510 may be executed by processor 502 to store information related to the containerized application in a database. Instructions 512 may be executed by processor 502 to create a new containerized application in the cloud system based on the information related to the containerized application in the database, in response to a future user request to access the containerized application. Instructions 514 may be executed by processor 502 to associate a new public service endpoint with the new containerized application in the cloud system. Instructions 514 may be executed by processor 502 to allow user access to the new containerized application in the cloud system via the new public service endpoint.

For the purpose of simplicity of explanation, the example methods of FIGS. 3 and 4 are shown as executing serially, however it is to be understood and appreciated that the present and other examples are not limited by the illustrated order. The example systems of FIGS. 1, 2, and 5, and methods of FIGS. 3 and 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method, comprising:
determining whether a containerized application in a cloud system has not been used for a pre-defined period of time;
in response to a determination that the containerized application in the cloud system has not been used for the pre-defined period of time, deleting the containerized application in the cloud system;
storing information related to the containerized application in a database;
in response to a future user request to access the containerized application, creating a new containerized application in the cloud system based on the information related to the containerized application in the database;
associating a new public service endpoint with the new containerized application in the cloud system; and
allowing user access to the new containerized application in the cloud system via the new public service endpoint.

2. The method of claim 1, wherein the information related to the containerized application comprises information related to a public service endpoint associated with the containerized application.

3. The method of claim 1, wherein the information related to the containerized application comprises information related to a storage location of persistent data of the containerized application

4. The method of claim 1, wherein creating the new containerized application comprises associating persistent data of the containerized application with the new containerized application.

5. The method of claim 1, further comprising retaining persistent data of the containerized application in the cloud system.

6. The method of claim 1, wherein the new public service endpoint is associated with the new containerized application by a user.

7. The method of claim 1, wherein the public service endpoint is a domain name.

8. The method of claim 1, wherein associating the new public service endpoint with the new containerized application in the cloud system comprises:
creating the new public service endpoint; and
associating the new public service endpoint with the new containerized application

9. A cloud system, comprising:
a determination engine to determine whether a containerized application in the cloud system has not been used for a pre-defined period of time;
a deletion engine to, in response to a determination that the containerized application in the cloud system has not been used for the pre-defined period of time, delete the containerized application in the cloud system;
a storage engine to store information related to the containerized application in a database, wherein the information related to the containerized application comprises information related to a public service endpoint associated with the containerized application, and information related to storage location of persistent data of the containerized application;
a container engine to, in response to a future request to access the containerized application, create a new containerized application in the cloud system based on the information related to the containerized application in the database;
an association engine to associate a new public service endpoint with the new containerized application in the cloud system; and
an access engine to allow access to the new containerized application in the cloud system via the new public service endpoint.

10. The cloud system of claim 9, wherein the determination engine to determine whether the containerized application in the cloud system has not been used for the pre-defined period of time, based on network utilization by the containerized application within the pre-defined period of time.

11. The cloud system of claim 9, wherein the determination engine to determine whether the containerized application in the cloud system has not been used for the pre-defined period of time, based on storage utilization by the containerized application within the pre-defined period of time.

12. The cloud system of claim 9, wherein the determination engine to determine whether the containerized application in the cloud system has not been used for the pre-defined period of time, based on CPU utilization by the containerized application within the predefined period.

13. The cloud system of claim 9, wherein the new public service endpoint is created by a user.

14. The cloud system of claim 9, wherein the cloud system includes a hybrid cloud system.

15. A non-transitory machine-readable storage medium comprising instructions, the instructions executable by a processor to:
determine whether a containerized application in a cloud system has not been used for a pre-defined period of time;
in response to a determination that the containerized application in the cloud system has not been used for the pre-defined period of time, delete the containerized application in the cloud system;
store information related to the containerized application in a database;
in response to a future user request to access the containerized application, create a new containerized application in the cloud system based on the information related to the containerized application in the database;
associate a new public service endpoint with the new containerized application in the cloud system; and
allow user access to the new containerized application in the cloud system via the new public service endpoint.

16. The storage medium of claim 15, wherein the new public service endpoint is a domain name.

17. The storage medium of claim 15, wherein the cloud system includes a private cloud system.

18. The storage medium of claim 15, wherein the database is present on the cloud system.

19. The storage medium of claim 15, wherein the information related to the containerized application comprises information related to exposed port mapping.

20. The storage medium of claim 15, wherein the information related to the containerized application comprises information related to environment variables passed to the containerized application.
